(19) United States
(12) Patent Application Publication
(10) Pub. No.: US 2023/0297482 A1
(43) Pub. Date: Sep. 21, 2023

(54) MANAGING ARTIFACT INFORMATION RELATING TO A PHYSICAL SYSTEM, FOR EXAMPLE IMPROVING TRACEABILITY OF RE-BASELINED ENGINEERING-RELATED INFORMATION, METHOD AND SYSTEM

(71) Applicant: Siemens Industry Software GmbH, Zürich (CH)

(72) Inventor: Nikolay Entin, Stuttgart (DE)

(21) Appl. No.: 18/122,346

(22) Filed: Mar. 16, 2023

Related U.S. Application Data
(63) Continuation of application No. PCT/EP2022/056972, filed on Mar. 17, 2022.

(51) Int. Cl. G06F 11/30

(52) U.S. Cl. CPC G06F 11/3041; G06F 11/302

(57) ABSTRACT

For an improved management of artifact information relating to a physical system, for example for an improved traceability of re-baselined engineering-related information, a computer-implemented method is suggested including: providing at least one first artifact item, wherein the respective first artifact item is assigned to a first artifact information baseline and to a subsequent second artifact information baseline; providing at least one second artifact item, wherein the respective second artifact item is linked with the respective first artifact item; assigning a change flag to the respective second artifact item if the respective first artifact item to which the respective second artifact item is linked has been changed from the first artifact information baseline to the second artifact information baseline; and displaying the respective second artifact item to which the change flag has been assigned to a user via an artifact information management user interface (UI).

### CROSS REFERENCE TO RELATED APPLICATIONS

This application claims the benefit of PCT Application Serial Number PCT/EP2022/056972, filed Mar. 17, 2022, designating the United States, which is hereby incorporated in its entirety by reference.

### FIELD

The present disclosure is directed, in general, to engineering systems, engineering management systems, systems engineering systems, and similar systems, such as computer-aided design (CAD), computer-aided manufacturing (CAM), computer-aided engineering (CAE), and electronic design automation (EDA), that are used to design, integrate, and manage physical systems, such as machines, structures, and other items, including bridges, tunnels, roads, vehicles, and buildings. The present disclosure is further directed, in general, to product lifecycle management (PLM) systems, application lifecycle management (ALM) systems, in particular for software, artifact information systems, and similar systems, that are used to create, use, and manage data for products including software and artifacts and other items. The mentioned systems are collectively referred to herein as product systems. Further, the present disclosure is directed, in general, to the interplay of the mentioned engineering systems and the PLM or ALM systems.

### BACKGROUND

Product systems may include stored content or artifact information associated with physical systems and product lifecycle information of physical systems. Such content or artifact information may include engineering information and lifecycle information of the physical system to be engineered. Currently, there exist product systems and solutions that support managing artifact information relating to a physical system. Such product systems may benefit from improvements.

### BRIEF SUMMARY AND DESCRIPTION

The scope of the embodiments is defined solely by the appended claims and is not affected to any degree by the statements within this summary. The present embodiments may obviate one or more of the drawbacks or limitations in the related art.

Variously disclosed embodiments include data processing systems and methods that may be used to facilitate managing artifact information relating to a physical system, for example improving traceability of re-baselined engineering-related information.

According to a first aspect, a computer-implemented method of managing artifact information may include: providing at least one first artifact item, wherein the respective first artifact item is assigned to a first artifact information baseline and to a subsequent second artifact information baseline; providing at least one second artifact item, wherein the respective second artifact item is linked with the respective first artifact item; assigning a change flag to the respective second artifact item if the respective first artifact item to which the respective second artifact item is linked has been changed from the first artifact information baseline to the second artifact information baseline; and displaying the respective second artifact item to which the change flag has been assigned to a user via an artifact information management user interface (UI).

According to a second aspect, a computer system may be arranged and configured to execute the steps of the computer-implemented method according to the first aspect.

According to a third aspect, a computer program product may include computer program code that, when executed by the computer system according to the second aspect, causes the computer system to carry out the method according to the first aspect.

According to a fourth aspect, a computer-readable medium may include the computer program product according to the third aspect. By way of example, the described computer-readable medium may be non-transitory and may further be a software component on a storage device.

### BRIEF DESCRIPTION OF THE DRAWINGS

FIGS. 1-4 illustrate a functional block diagram of an example system according to an embodiment that facilitates managing artifact information relating to a physical system, for example improving traceability of re-baselined engineering-related information, in a product system, respectively.

FIGS. 5-6 illustrate example scenarios of artifact information according to an embodiment in the context of managing artifact information relating to a physical system, for example improving traceability of re-baselined engineering-related information, in a product system, respectively.

FIG. 7 depicts a flow diagram of an example methodology that facilitates managing artifact information relating to a physical system according to an embodiment, for example improving traceability of re-baselined engineering-related information, in a product system.

FIG. 8 depicts a block diagram of a data processing system according to an embodiment.

### DETAILED DESCRIPTION

Various technologies that pertain to systems and methods for managing artifact information relating to a physical system, for example improving traceability of re-baselined engineering-related information, in a product system will now be described with reference to the drawings, where like reference numerals represent like elements throughout. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements.

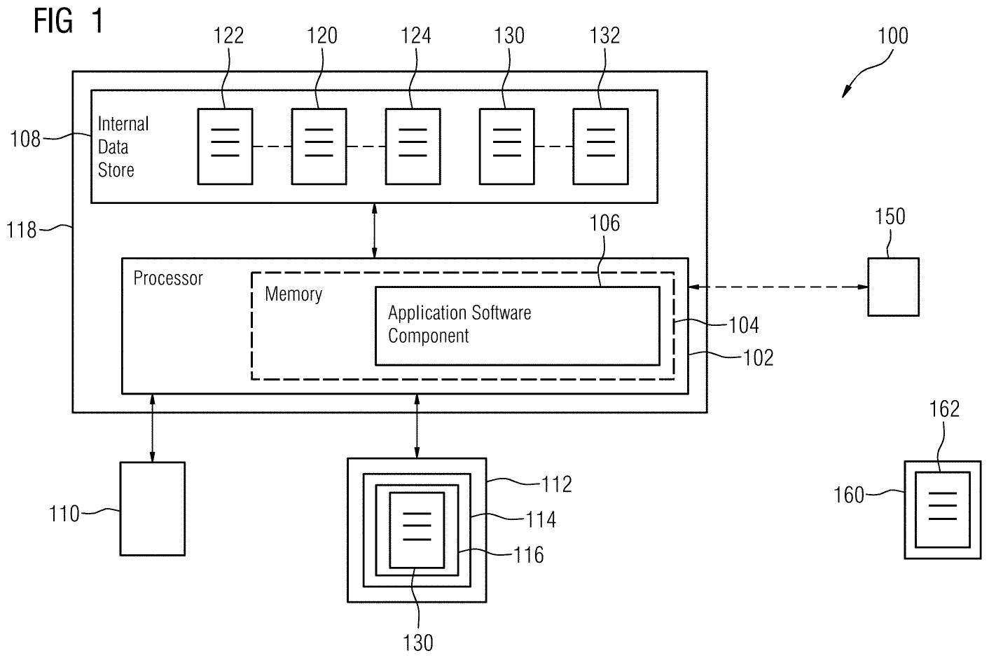

With reference to FIG. 1, a functional block diagram of an example data processing system 100 is depicted that facilitates managing artifact information relating to a physical system 150, for example improving traceability of re-baselined engineering-related information. The data processing system 100 may, in some examples, include an artifact information management system 118 or more generally a computer system allowing for artifact information management by providing corresponding functionalities to a user. The artifact information management system 118 may include at least one processor 102 that is configured to execute at least one application software component 106 from a memory 104 accessed by the processor 102. The application software component 106 may be configured (i.e., programmed) to cause the processor 102 to carry out various acts and functions described herein. For example, the described application software component 106 may include and/or correspond to one or more components of an engineering software application, such as a CAD, CAM, CAE, or EDA software application or PLM or ALM software application that is configured to generate and store product data in a data store 108 such as a database.

In some examples, the artifact information may include engineering artifact information and/or lifecycle artifact information. By way of example, the artifact information management system 118 may allow for the engineering a physical system 150 by providing corresponding functionalities to a user and by creating, amending, or managing corresponding engineering artifact information relating to the physical system 150. In such examples, the artifact information management system 118 may include or be part of an engineering system. The artifact information management system 118 may, e.g., may allow for the management of lifecycle information by providing corresponding functionalities to a user and by creating, amending, or managing corresponding lifecycle information relating to the physical system 150. In such examples, the artifact information management system 118 may include or be part of a product lifecycle management system. By way of example, the engineering artifact information may relate to physical, mechanical, electrical, electronic, hydraulic, thermal, control, electric power and/or process-oriented information of the physical system. Further, the lifecycle artifact information may, e.g., relate or include to the conception, requirements, uses cases, issues, design, realization and/or service information of the physical system 150. In further examples, the lifecycle artifact information may, e.g., include data records representing/storing data corresponding to parts, tools, documents, process descriptions, templates, materials, requirements specifications, software products, or software applications relating to the physical system 150, respectively. In further embodiments, the lifecycle artifact information may include test information, test cases, test management information or risk assessments with respect to the physical system 150, whereby the test information, test cases, test management information or risk assessments may be used to qualify the physical system 150 as compliant with certain requirements or specifications or to find issues of the physical system 150. Such test information, test cases, test management information or risk assessments may further be available for different variants of the physical system 150, e.g., standard, premium, luxury variants of a car, low-, middle, high-power output machines, etc. An issue identified for at least one variant of the physical system 150 using the test information, test cases, test management information or risk assessments may equally apply to the other variants of the physical system 150. Hence, an issue identified for at least one variant of the physical system 150 may easily be checked or verified for the other variants of the physical system 150.

It should be appreciated that in some examples, the physical system 150 may include or be a sensor, an actuator, such as an electric motor, a valve or a robot, an inverter supplying an electric motor, a gear box, a programmable logic controller (PLC), a communication gateway, and/or other parts or components relating to industrial automation products and industrial automation in general. The physical system 150 may be part of a complex production line or production plant, e.g., a bottle filing machine, conveyor, welding machine, welding robot, etc. In some examples, the physical system 150 may be a smartphone, smartwatch, handheld, pad, laptop or the like, or a desktop device, e.g., including desktop computers, or other “smart” devices, e.g., smart television sets, fridges, home or industrial automation devices. Smart television sets may e.g., be a television set with integrated Internet capabilities or a set-top box for television that offers more advanced computing ability and connectivity than a contemporary basic television set. Further, by way of example, the physical system 150 may include or be any machine, structure, or other items, including bridges, tunnels, roads, vehicles, and buildings, that may be engineered.

Examples of engineering systems that may be adapted to include the some of the features described herein may include Simcenter Amesim, an application produced by Siemens Industry Software NV, of Leuven, Belgium, the NX suite of applications or Solid Edge applications produced by Siemens Industry Software Inc., of Plano, Texas, USA or the Totally Integrated Automation (TIA) Portal, an application produced by Siemens Aktiengesellschaft, of Munich, Germany. Examples of PLM systems that may be adapted to support the features described herein may include the Active Workspace features of Teamcenter, an application produced by Siemens Industry Software Inc., of Plano, Texas, USA. Examples of ALM systems that may be adapted to support the features described herein may include Polarion ALM, an application produced by Siemens Industry Software GmbH, of Zurich, Switzerland. However, it should be appreciated that the systems and methods described herein may be used in other product systems (e.g., PLM, PDM, ALM systems) and/or any other type of system that generates and stores product data in a database. Also, examples of databases that may be used as one or more data stores described herein include database server applications such as Oracle, Microsoft SQL Server, or any other type of data store that is operative to store data records.

By way of example, the artifact information management system 118 may be cloud-based, internet-based and/or be operated by a provider providing artifact information management support, including, e.g., comparing and merging artifact information or improving the traceability of re-baselined engineering-related information. The user may be located close to the artifact information management system 118 or remote to the artifact information management system 118, e.g., anywhere else, e.g., using a mobile device for connecting to the artifact information management system 118, e.g., via the internet. The user's device may include an input device 110 and a display device 112. In some examples, the artifact information management system 118 may be installed and run on a user's device, such as a computer, laptop, pad, on-premises computing facility, or the like.

It should be appreciated that it may be difficult and time-consuming to manage artifact information (e.g., data records representing/storing data corresponding to parts, tools, documents, process descriptions, templates, materials, requirements specifications, test information, test cases, test management information or risk assessments, software products, software applications) in complex, production engineering, PLM or ALM environments. For example, artifact information may be spread in several if not many artifact documents. The artifact documents may be large files including comprehensive artifact information. Further, the artifact information and the artifact documents may include many commits or revisions, e.g., relating to a software being developed. Herein, a commit may be understood as a change in source code or in the artifact information that is committed and pushed in a GitHub repository offered by GitHub, Inc. of San Francisco, CA, USA that provides hosting for software development and version control using Git. It offers the distributed version control and source code management (SCM) functionality of Git. Further, a revision may be understood as a change in source code or in the artifact information that is committed and pushed in an Apache Subversion repository (often abbreviated SVN) offered by Apache Software Foundation that is a software versioning and revision control system distributed as open source under the Apache License. Additionally, a baseline may, e.g., in the context of configuration management be understood as an agreed description of the attributes of a product, such as the physical system 150, at a point in time, that serves as a basis for defining change. A change may in this context be a movement from this baseline state to a next state. The identification of significant changes from the baseline state may be the central purpose of baseline identification. Typically, significant states are those that receive a formal approval status, either explicitly or implicitly. Such states may, e.g., in the context of hardware development relate to a first function sample (in the automotive industry: “A-sample”), a testing sample (“B-sample”, adjusted to the available installation space, incl. all functions) or a close-to-series sample (zero batch or “C-sample”), or in the context of software development relate to different versions of a software product. Further, a baseline may also mark an approved configuration item, e.g., a project plan that has been signed off for execution. In a similar manner, associating multiple configuration items with such a baseline may indicate those items as being approved.

It should be appreciated that a reliable and efficient traceability of re-baselined engineering-related information may be challenging. By way of example, the artifact information may include a first artifact item 120 that may relate to the lifecycle of the physical system 150 and a linked second artifact item 130 that is linked to the first artifact item 120, and that may relate to the engineering of the physical system 150. If the first artifact item 120 is changed through a more recent revision that is taken into account during a re-baselining, the traceability of the first artifact item 120 may get lost, e.g., such that the second artifact item 130 may be linked to the old version of the first artifact item 120. A lost traceability of the first artifact item 120 may, e.g., also occur if the existence, the non-existence or the extent of changes to the first artifact item 120 in the context of the re-baselining may not fully or not correctly be reflected by or be visible through the second artifact item 130. By way of example, the first artifact item 120 may include a requirement relating to the physical system 150 and the linked second artifact item 130 may be a test case to verify this requirement. If the first artifact item 120 is changed or unchanged from an earlier baseline to a later baseline and the test case had been successfully completed for the earlier baseline, re-doing the test of the test case may be necessary or may not be necessary, respectively. In some examples, managing artifact information, for example safeguarding a reliable and efficient traceability of re-baselined engineering-related information, may require many conscious selections and inputs by trained and experienced users or may require large computation or memory resources that may be an error-prone, slow or not efficient process.

By way of example, the described processing system 118 or 100 may include at least one input device 110 and at least one display device 112 (such as a display screen). The described processor 102 may be configured to generate a graphical user interface (GUI) 114 through the display device 112. Such a GUI may include GUI elements such as buttons, links, search boxes, lists, text boxes, images, scroll bars) usable by a user to provide inputs through the input device 110 that cause managing artifact information.

To enable the enhanced management of artifact information relating to a physical system 150, for example improving traceability of re-baselined engineering-related information, the application software component 106 and/or the processor 102 may, in some examples, be configured to provide at least one first artifact item 120. The respective first artifact item 120 is assigned to a first artifact information baseline 122 and to a subsequent second artifact information baseline 124. In some examples, the respective first artifact item 120 may be changed or may be unchanged from the first artifact information baseline 122 to the second artifact information baseline 124. The respective first artifact item 120 may, e.g., include a requirement relating to the physical product 150. The first artifact information baseline 122 and the second artifact information baseline 124 may, e.g., correspond to the above-mentioned first function sample and the testing sample or to different versions, respectively, e.g., of the physical product 150. Changes to the respective first artifact item 120 may, e.g., be done in the context of different revisions, as explained above. By way of example, the respective first artifact item 120 of an earlier revision may then be assigned to the first artifact information baseline 122 and the respective first artifact item 120 of the same revision (if the respective first artifact item 120 is unchanged) or of a later revision (if the respective artifact item 120 is changed in the meantime) may then be assigned to the second artifact information baseline 124.

It should be appreciated, that in some examples, the application software component 106 and/or the processor 102 may further be configured to provide at least one second artifact item 130. The respective second artifact item 130 is linked with the respective first artifact item 120. In some examples, the respective second artifact item 130 may depend on the respective first artifact item 120. For example, the respective second artifact item 130 may include test information, test cases or test management information. The corresponding test may be performed using the linked, respective first artifact item 120. It should be appreciated, that in some examples, the respective second artifact item 130 may be linked to a plurality of the first artifact items 120 and that the corresponding test may depend on the plurality of the linked first artifact items 120. Further, it should be appreciated, that changes made to the respective first artifact item 120 may affect the respective second artifact item 130, e.g., by necessitating an update of the respective second artifact item 130 or by at least checking if an update of the respective second artifact item 130 may be necessary.

In further examples, the application software component 106 and/or the processor 102 may further be configured to assign a change flag 132 to the respective second artifact item 130 if the respective first artifact item 120 to which the respective second artifact item 130 is linked has been changed from the first artifact information baseline 122 to the second artifact information baseline 124.

To assign the change flag 132 to the respective second artifact item 130, the application software component 106 and/or the processor 102 may, e.g., be configured to determine if the respective first artifact item 120 that is assigned to the second artifact information baseline 124 is different from the respective first artifact item 120 that is assigned to first artifact information baseline 122, i.e., if the respective first artifact item 120 has been changed from the first artifact information baseline 122 to the second artifact information baseline 124. In some examples, the mentioned determination if the respective first artifact item 120 has been changed may be done by comparing the respective revision of the respective first artifact item 120 that is assigned to the first artifact information baseline 122 with the respective revision of the respective first artifact item 120 that is assigned to the second artifact information baseline 124. In some examples, the mentioned determination if the respective first artifact item 120 has been changed may be done by directly comparing the respective first artifact item 120 that is assigned to the first artifact information baseline 122 with the respective first artifact item 120 that is assigned to the second artifact information baseline 124. Hereby, a change of the respective first artifact item 120 may, e.g., be understood as an amendment to the respective first artifact item 120.

The change flag 132 may be assigned to the respective second artifact item 130 that is linked to the respective first artifact item 120 that has been changed or amended from the first artifact information baseline 122 to the second artifact information baseline 124. The change flag 132 may help to identify the respective second artifact item 130 that may be affected by changes made to the linked, respective first artifact item 120 between the first artifact information baseline 122 to the second artifact information baseline 124.

The change flag 132 may allow the user to adequately take care of the respective second artifact item 130, e.g., by checking if or how the changes made to the linked, respective first artifact item 120 may affect the respective second artifact item 130 and, e.g., by further checking, if applicable, what measures may need to be taken to adequately take the changes made to the linked, respective first artifact item 120 into account. If, e.g., the respective first artifact item 120 includes a requirement relating to the physical system 150 and the linked respective second artifact item 130 includes a test case for this requirement, then measures that may need to be taken if the respective first artifact item 120 has been changed may include re-doing the test of the test case for the changed, respective first artifact item 120. Accordingly, in this example, if the respective first artifact item 120 has not been changed, the test of the test case may not need to be re-done since the outcome would still be the same.

Consequently, the change flag 132 may also help to identify the respective second artifact item 130 that may not be affected by changes made to the linked, respective first artifact item 120 between the first artifact information baseline 122 to the second artifact information baseline 124. There may, e.g., be another respective first artifact item 120 that may be changed, but that is, however, not linked to the respective second artifact item 130. Recognizing the unaffected respective second artifact item 130 is of advantage, since this may help to reduce the efforts to check if or how the changes made to the linked, respective first artifact item 120 may affect the respective second artifact item 130 (that they don't in this case) and may further reduce the efforts to check what measures may need to be taken to adequately take the changes made to the linked, respective first artifact item 120 into account (that is not necessary in this case).

It should be appreciated, that in some typical example scenarios, the development of the physical system 150 may involve many respective first artifact items 120, such as thousands or tens or hundreds of thousands of requirements, and a considerable number of respective second artifact items 130, such as hundreds or thousands of test scenarios links to the requirements. Accordingly, the mentioned reduction of efforts that may, in some examples, be achieved thanks to the mentioned change flag 132 may constitute a considerable improvement, e.g., by reducing the time and costs for the development of the physical system 150 and/or by reducing potential error sources and/or by improving the overall product quality of the physical system 150.

In some examples, the respective second artifact item 130 may newly be introduced in the subsequent second artifact information baseline 124, so that the respective second artifact item 130 may have no precursor in the preceding first artifact information baseline 122. In such examples, the change flag 132 or a new flag may optionally be assigned to the respective second artifact item 130. The assigned change flag 132 or new flag may indicate to the user that the respective second artifact item 130 may require his or her attention, e.g., to do a test of a test case included by the respective second artifact item 130 for the first time with respect to the linked requirement that may be included by the respective first artifact item 120.

By way of example, the application software component 106 and/or the processor 102 may further be configured to display the respective second artifact item 130 to which the change flag 132 has been assigned to a user via an artifact information management user interface (UI) 116. Displaying the change flag 132 may allow the user to adequately take care of the respective second artifact item 130 as described above, e.g., by checking if or how the changes made to the linked, respective first artifact item 120 may affect the respective second artifact item 130 and, e.g., by further checking, if applicable, what measures may need to be taken to adequately take the changes made to the linked, respective first artifact item 120 into account. In this way, the user may, e.g., be directed to only those of the respective second artifact item(s) 130 that may require his or her attention, whereas other respective second artifact item(s) 130 that do not require his or her attention may, e.g., not be displayed to the user.

In some examples, the application software component 106 and/or the processor 102 may further be configured—with respect to the respective first artifact item 120 that is linked with the respective second artifact item 130 to which the change flag 132 has been assigned—to display information about the respective first artifact item 120 and/or information about the change(s) made to the respective first artifact item 120 from the first artifact information baseline 122 to the second artifact information baseline 124 to the user via an artifact information management UI 116.

The information about the linked, respective first artifact item 120 may, e.g., include the linked, respective first artifact item 120, when or by who the change(s) have been made. The information about the change(s) made to the respective first artifact item 120 may, e.g., include the change(s) made to the respective first artifact item 120, if or how the change(s) made to the respective first artifact item 120 might affect the respective second artifact item 130. In some examples, if or how the change(s) made to the respective first artifact item 120 might affect the respective second artifact item 130 may be determined by the artifact information management system 118, e.g., the engineering system and/or the product lifecycle system. Displaying the mentioned information about the respective first artifact item 120 and/or information about the change(s) made to the respective first artifact item 120 may help the user to quickly assess if or what measures may need to be taken to adequately take the changes made to the linked, respective first artifact item 120 into account.

By way of example, the application software component 106 and/or the processor 102 may further be configured to highlight the displayed respective second artifact item 130 to which the change flag 132 has been assigned.

The respective second artifact item 130 to which the change flag 132 has been assigned may be displayed and highlighted in the artifact information management UI 116, e.g., using colors, bold font, animations, or the like. Highlighting the respective second artifact item 130 with the assigned change flag 132 may help the user to quickly identify those of the respective second artifact item(s) 130 that may require his or her attention. Highlighting the respective second artifact item 130 with the assigned change flag 132 may, in some examples, be particularly helpful if other, respective second artifact item(s) without an assigned change flag 132—and that therefore may not require the user's attention—are also displayed to the user via the artifact information item UI 116.

In some examples, the above-mentioned information about the respective first artifact item 120 and/or information about the change(s) made to the respective first artifact item 120 may also be highlighted.

In further examples, the respective second artifact item 130 to which no change flag 132 has been assigned may not be displayed to the user via the artifact information management UI 116 and/or may not be highlighted.

Accordingly, among the respective second artifact item(s) 130, only those of the respective second artifact item 130 may be displayed to the user and optionally be highlighted via artifact information management UI 116 to which the change flag 132 has been assigned, whereas the respective second artifact item 130 to which no change flag 132 has been assigned may not be displayed or not be highlighted to the user via artifact information management UI 116. This selective display of the respective second artifact item 130 to which the change flag 132 has been assigned may further contribute to allow the user to quickly identify those of the respective second artifact item(s) 130 that may require the user's attention.

It should also be appreciated, that in some examples, the application software component 106 and/or the processor 102 may further be configured to determine if the respective change of the respective first artifact item 120 from the first artifact information baseline 122 to the second artifact information baseline 124 does not affect the respective linked second artifact item 130; and to remove the change flag 132 from the respective second artifact item 130 if the respective second artifact item 130 is not affected by the respective change of the respective first artifact item 120 to which the respective second artifact item 130 is linked.

Removing the change flag 132 from the respective second artifact item 130 may, e.g., be understood as removing the assignment of the change flag 132 to the respective second artifact item 130.

By way of example, the respective change of the respective first artifact item 120 may be such that the linked second artifact information item 130 may not be affected by the mentioned, respective change. This may, e.g., be the case if the respective change concerns trivial properties of the respective first artifact item 120. Further, this may, in some examples, be the case if the respective change concerns a property or content of the respective first artifact item 120 that is irrelevant to the linked, respective second artifact item 130. By way of example, the respective first artifact item 120 may relate to requirements of a housing of the physical system 150, whereby the requirements include the color of the housing that was chosen to be blue at the first artifact information baseline 122, and whereby the color has been changed to be yellow at the second artifact information baseline 124. The linked, respective second artifact item 130 may, e.g., relate to a mechanical stability test scenario of the physical system 150. Whereas some changes to the respective first artifact item 120 might affect the linked, respective second artifact item 130, such as changing the material or the geometry of the housing, the changed color of the housing does not affect the linked, respective second artifact item 130. Accordingly, the change flag 132 may be removed from the linked, respective second artifact item 130.

It should be appreciated that the examples may, e.g., aim to reduce the number of respective second artifact items 130 with an assigned change flag 132 and may hence aim to reduce the user's efforts, e.g., for checking if or how the changes made to the linked, respective first artifact item 120 may affect the respective second artifact item 130 and, if applicable, what measures may need to be taken to adequately take the changes made to the linked, respective first artifact item 120 into account. Hence, the examples may help to considerably increase the efficiency of the whole artifact information management process and of the engineering process of the physical system 150.

It should be appreciated, that in some examples, the respective second artifact item 130 may be linked to two or more first artifact items 120. In such examples, a respective change flag 132 may be assigned to the respective second artifact item 130 for each changed and linked first artifact item 120. Hence, in some scenarios, it may occur that one or more change flag(s) 132 may be removed as described above, while another change flag 132 may still be assigned to the respective second artifact item 130 so that the respective second artifact item 130 may still be displayed to the user and optionally be highlighted via the artifact information management UI 116.

In some examples, the respective second artifact item 130 may not be affected by the respective change of the respective first artifact item 120 to which the respective second artifact item 130 is linked if the respective change relates to an attribute or a priority of the respective first artifact item 120.

An attribute of the respective first artifact item 120 may, e.g., be understood as a specification that defines a property of the respective first artifact item 120. An attribute may, in some examples, be considered as metadata of the respective first artifact item 120. For example, an attribute of the respective first artifact item 120 may be the name of the author or the date of the creation or latest amendment of the respective first artifact item 120. Further, an attribute may, e.g., be a comment for better readability or understandability that may be included by the respective first artifact item 120.

A priority of the respective first artifact item 120 may, e.g., be a value representing the priority or importance of the respective first artifact item 120, for example in cases of conflicting first artifact items 120. The values may, e.g., be a value between 0 and 100, whereby a low priority may have a value of at least 10, a medium priority may have a value of at least 50, and a high priority may have a value of at least 90. In some examples, there may be priorities like “must have”, “critical”, “should have”, “major”, “nice to have”, “normal”, “basic”, or “minor”.

In some examples, if the respective change relates to an attribute or a priority of the respective first artifact item 120, the linked, respective second artifact item 130 may not be affected by this respective change.

By way of example, the application software component 106 and/or the processor 102 may further be configured to receive the user's or an administrator's input corresponding to a definition of at least one change of the respective first artifact item 120 to which the respective second artifact item 130 is linked, whereby the respective defined change may not affect the respective second artifact 130.

The administrator may, in some examples, be a person who is responsible for the upkeep, configuration, and reliable operation of the artifact management system 118. The administrator may, e.g., seek to ensure that the uptime, performance, resources, and security of the artifact management system 118 they manage meet the needs of the users, without exceeding a set budget when doing so. Further, the administrator may have detailed knowledge on the engineering and/or lifecycle management process, and optionally on the physical system.

The administrator or the user, for example a skilled and an experienced user, may provide the definition of at least one change that may not affect the respective second artifact 130. Hence the administrator or the user may, e.g., define what may still be considered to correspond to the above-mentioned trivial properties of the respective first artifact item 120 that may be changed, and that do not affect the linked, respective second artifact item 130.

In some examples, the respective defined change may include one or more types or categories of changes of the respective first artifact item 120.

Using such defined changes may, e.g., help to further increase the efficiency of the whole artifact information management process.

In further examples, the application software component 106 and/or the processor 102 may further be configured to display a UI element 138 indicating the intended removal of the change flag 132 from the respective second artifact item 130 to the user via the artifact information management UI 116; to capture the user's intent to confirm or reject the intended removal of the change flag 132 from the respective second artifact 130 in response to user interactions with the artifact information management UI 116; and to remove the change flag 132 from the respective second artifact item 130 if the captured user's intent corresponds to a confirmation the intended removal of the change flag 132 from the respective second artifact item 130.

In the examples, the user may quickly glimpse over the intended removal of the respective change flag 132. The user may regularly accept the intended removal of the respective change flag 132. Further, the user may reject the intended removal of the respective change flag 132, e.g., only if he or she thinks that a closer look might be necessary that regularly may seldomly be the case. In some examples, the change flag 132 may be removed from the respective second artifact item 130 only if the captured user's intent corresponds to a confirmation the intended removal of the change flag 132 from the respective second artifact item 130.

Giving the user the possibility to confirm or reject the intended removal of the change flag 132 may, in some examples, be used to facilitate and accelerate sorting out uncritical changes to the respective first artifact item 120, while still providing full control over the process to the user.

It should also be appreciated, that in some examples, the application software component 106 and/or the processor 102 may further be configured to provide a respective connector 134 linking the respective second artifact item 130 with the respective first artifact item 120 assigned to the first artifact information baseline 122; and to replace the respective connector 134 with a respective updated connector 136 linking the respective second artifact item 130 with the respective first artifact item 120 assigned to the second artifact information baseline 124.

By way of example, the respective connector 134 and/or the respective updated connector 136 may include a Uniform Resource Identifier (URI), a Uniform Resource Locator (URL), a Requirements Interchange Format (ReqIF) element, an Open Services for Lifecycle Collaboration (OSLC) element and/or a Resource Description Framework (RDF) element.

Herein, a URI may be understood as a unique sequence of characters that identifies a logical or physical resource used by web technologies. URIs may be used to identify information resources such as web pages or databases. Some URIs provide a means of locating and retrieving information resources on a network (either on the Internet or on another private network, such as a computer filesystem or an Intranet); these may be Uniform Resource Locators (URLs) that are described in more detail below. A URI may identify the resource by name at the specified location or URL. The web technologies that use URIs are not limited to web browsers. URIs are used to identify anything described using the Resource Description Framework (RDF), for example, concepts that are part of an ontology defined using the Web Ontology Language (OWL).

A Uniform Resource Locator (URL), colloquially termed a web address, may be a reference to a web resource that specifies its location on a computer network and a mechanism for retrieving it. A URL is a specific type of Uniform Resource Identifier (URI). URLs occur most commonly to reference web pages (http) but are also used for file transfer (ftp), email (mailto), database access (JDBC), and many other applications.

It should be appreciated that the respective connector 134 and/or the respective updated connector 136 including a URI or URL may, in some examples, be used for synchronous or for asynchronous communication or operations involving the respective first artifact item 120 and the respective second artifact item 130.

The Requirements Interchange Format (RIF or ReqIF) is an XML file format that may be used to exchange requirements, along with its associated metadata, between software tools from different vendors. The requirements exchange format may also define a workflow for transmitting the status of requirements between partners. Although developed in the automotive industry, ReqIF is suitable for lossless exchange of requirements in any industry.

In some examples, an ReqIF element may always be offline. An ReqIF element may preserve information about the source and target of the link, e.g., the respective connector 134 and/or the respective updated connector 136 but, cannot ensure the existence of either at time the file or the data is imported in the corresponding target system. This aspect may, in some examples, lead to the creation of items in the target system, e.g., the respective connector 134 and/or the respective updated connector 136, that were previously deleted in the source system. This aspect may further lead to ignoring a part of the ReqIF content, e.g., the respective connector 134 and/or the respective updated connector 136, as the corresponding target system has no information that the items were deleted in the source system and ignores them on import to the target system.

An Open Services for Lifecycle Collaboration (OSLC) element may be understood as an element corresponding to the OSLC set of specifications that enable integration of software development. OSLC has evolved, and continues to evolve, to areas such as ALM, PLM, IT Operations and more, whereby OSLC intends to make life easier for tools users and tools vendors, by making it easier for tools to work together. Among others, OSLC specifications build on the World Wide Web Consortium (W3C) Resource Description Framework (RDF). RDF has originally been designed as a data model for metadata. It has come to be used as a general method for description and exchange of graph data. RDF provides a variety of syntax notations and data serialization formats with Turtle (Terse RDF Triple Language) currently being the most widely used notation.

In some examples, the respective connector 134 and/or the respective updated connector 136 may include a URL to allow for import or synchronization of lifecycle information from a lifecycle database included by a lifecycle management system to an engineering database included by an engineering system. By way of example, the respective connector 134 and/or the respective updated connector 136 may include the web address and/or memory address of the lifecycle database and optionally of the respective lifecycle artifact stored in the lifecycle database. The respective connector 134 and/or the respective updated connector 136 may further include the web address and/or memory address of the engineering database and optionally the web address and/or memory address to which the mentioned lifecycle information is to be imported or synchronized. In some examples, the respective first artifact item 120, the first artifact information baseline 122, and the second artifact information baseline 124 may be stored in the lifecycle database, and the respective second artifact item 130 may be stored in the engineering database.

By way of example, the respective connector 134 and/or the respective updated connector 136 may include a ReqIF element to allow for import or synchronization of engineering information from the engineering database to the lifecycle database.

In some examples, the respective ReqIF element may allow for the desired import, optionally with a unique identifier. In further examples, the respective connector 134 and/or the respective updated connector 136 includes a URI or a URL and a ReqIF element including the lifecycle information to be imported or synchronized. Herein, the ReqIF element may first be exported from the lifecycle database (when the lifecycle database is available for communication) and then be imported to the engineering database (when the engineering database is available for communication). The respective connector 134 and/or the respective updated connector 136 may therefore be used for synchronous or asynchronous communication from the lifecycle database to the engineering database and further be used for asynchronous communication from the engineering database to the lifecycle database.

In some examples, the respective first artifact item 120 and/or the respective second artifact item 130 may relate to engineering information or lifecycle information of a physical system 150, respectively.

In some examples, the data processing system 100 or the artifact management system 118 may include an engineering system that may allow for the engineering the physical system 150 by providing corresponding engineering functionalities to a user and by creating, amending, or managing corresponding engineering information relating to the physical system 150. In further examples, the data processing system 100 or the artifact management system 118 may include a product lifecycle management system that may, e.g., allow for the management of lifecycle information by providing corresponding product lifecycle management functionalities to a user and by creating, amending, or managing corresponding product lifecycle information relating to the physical system 150. By way of example, the engineering information may relate to physical, mechanical, electrical, electronic, hydraulic, thermal, control, electric power and/or process-oriented information of the physical system. Further, the product lifecycle information may, e.g., relate or include to the conception, requirements, uses cases, issues, design, realization and/or service information of the physical system 150.

In some examples, the respective first artifact item 120 may relate to product lifecycle information of the physical system 150, and the respective second artifact item 130 may relate to engineering information of the physical system 150. Further, the respective first artifact item 120 may be stored in the lifecycle database, and the respective second artifact item 130 may be stored in the engineering database.

By way of example, the application software component 106 and/or the processor 102 may further be configured to engineer, model, simulate and/or analyze the physical system 150 using the respective first artifact item 120 and/or the respective second artifact item 130.

Hence, in some examples, a simulation of the physical system 150 may be carried out taking into account the respective first artefact information 120, e.g., relating to lifecycle information, and the respective second artifact item 130, e.g., relating to engineering information. In some examples, the respective first artefact information 120 of the physical system 150 may have been changed. The changed, respective first artefact information 120 may, e.g., relate to an amended property or an amended requirement of the physical system 150, such as a lower weight, smaller size, a higher output power, etc., of the physical system 150. This amendment may, in some examples, be used as a boundary condition, e.g., in the form of a corresponding test scenario that may be included by the respective second artifact item 130, that the physical system 150 may need to comply with and one or more simulations may be run, e.g., with varying engineering information to find amended engineering information that characterizes a physical system 150 complying with the amendment. Analogously, modeling, analyzing, or engineering the physical system 150 may be done taking into account the amendment in order to obtain amended engineering information that characterizes a physical system 150 complying with the amended requirement.

Engineering, modeling, simulating and/or analyzing the physical system 150 may, by way of example, include considering the time-varying behavior of the dynamical, physical system 150. Such physical systems 150 may, e.g., be described by ordinary differential equations or partial differential equations. A simulation or calculation run may solve the state-equation system to find the behavior of the state variables over a specified period of time. The equation(s) may be solved through numerical integration methods to produce the transient behavior of the state variables. Simulation of dynamic physical systems 150 may predict the values of model-system state variables, as they are determined by the past state values. This relationship may be described or characterized by an according model of the physical system 150.

It should also be appreciated, that in some examples, if the respective first artifact item 120 and/or the respective second artifact item 130 relates to engineering information, the application software component 106 and/or the processor 102 may further be configured to measure or determine the respective first artifact item 120 and/or the respective second artifact item 130 relating to engineering information of the of the physical system 150, e.g., using a sensor, computer-aided design (CAD) data, communication data, etc. relating to the physical system 150.

By way of example, some or all of the engineering information may be measured or determined using a sensor that may, e.g., be suitable to measure or determine the respective engineering information, such as mechanical, thermal, etc. information of the physical system 150. Further, some or all of the engineering information may be measured or determined using CAD data that may, e.g., determined, and in some cases read in, using a specification plate, e.g., an electronic specification plate, of the physical system 150. Herein, the (electronic) specification plate may include the CAD data or a sort of link that allows to access or download the CAD data. In further examples, some or all of the engineering information may be measured or determined using communication data of the physical system 150 that is communicatively coupled to another device. Herein, the communication data may, e.g., be used to determine control information or process-oriented information of the physical system 150.

It should be appreciated, that in some examples, some or all of the engineering information may be measured or determined using the respective (real) physical system 150 as indicated in FIG. 1 with the dashed line connecting the processor 102 of the engineering system 118 with the physical system 150.

It should further be appreciated that the suggested approach for facilitating managing artifact information relating to a physical system 150, for example for improving traceability of re-baselined engineering-related information may offers several advantages. The suggested approach offers users the advantage to reduce the efforts to check if or how the changes made to the linked, respective first artifact item 120 may affect the respective second artifact item 130. Further, the efforts to check what measures may need to be taken to adequately take the changes made to the linked, respective first artifact item 120 into account may be reduced. Hence, the suggested approach may, e.g., require may considerably fewer conscious selections and inputs by trained and experienced users and may reduce the computation or memory resources required for the management of artifact information relating to a physical system 150. Further, the suggested approach is less error-prone, faster and more efficient than other approaches for the management of artifact information relating to a physical system 150.

In some practical examples, a customer may work in a heterogenous data-model environment, where some of the artifact information is baselined, while other is not. Some scenarios may include, whereby the term ‘requirement’ may only serve as example and might be replaced by many other types of the respective first artifact item 120): Requirements (as the respective first artifact item 120) with test cases (as the linked, respective first artifact item 130): while requirements may often be baselined or tagged to reflect a product/release cycle, test cases may often be live without baselining, though with simple linking from head (i.e., the latest or current) revision. In some approaches, rather a copy of the test case is created for the new release or baseline than making a continuous evolution of test cases along with yet-in-progress requirements. Requirements (as the respective first artifact item 120) and Risk assessments (as the linked, respective first artifact item 130): it may be important to reassess risks associated to the requirements. In some approaches, those risks may be evaluated just between releases (or baselines), and it may make less sense to do it more often. Requirements (as the respective first artifact item 120) to models or source code (as the linked, respective first artifact item 130): after the requirements are released, models/sources may need to be updated accordingly.

In such practical examples, when requirements (as the respective first artifact item 120) are changed, the user may desire to preserve linked artifacts (i.e., the linked, respective first artifact item 130) as-is, if there was no change of particular requirement, while highlighting those (the respective first artifact item 120 or the linked, respective second artifact item 130), that were modified or affected by the modification to propagate the change to the linked artifacts (testcases, risk assessments, models, sources, etc., i.e., the linked, respective first artifact item 130).

Now, whenever a next release is approaching, approved requirements may be baselined again, and depending on the maintenance cycle, test cases should be re-routed to those requirements, or relinked (new links to be created between the test case and new revision of the Requirement.

While this process may relatively be often used on practice with more or less automation, the suggested approach may particularly contribute to highlight what has been changed between the releases, and to identify which of the test cases must be actualized because of that change. Hence, the suggested approach may involve a sort of suspect-link management. The suggested approach may involve an automated way of: moving (or re-creating of) the links between the head-version artifacts (latest test cases in the example above) and the baselines, from old to the new; comparing the target requirement document from baseline Y (later baseline) to baseline X (earlier baselin) to identify the differences; and setting suspect flags (the change flags 132) for those links between test cases and requirements, where requirement content has changed.

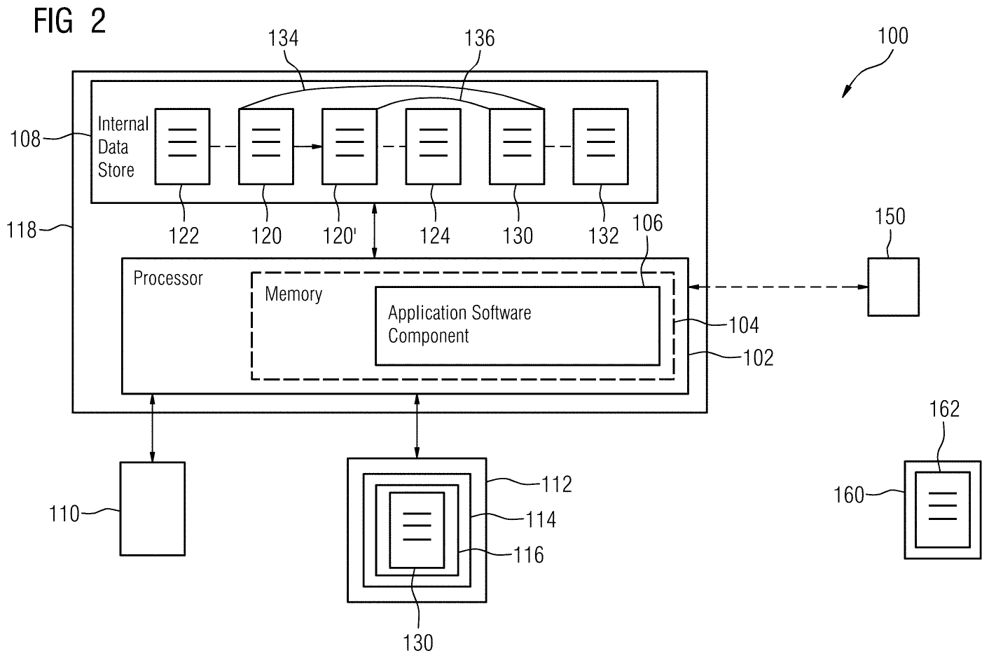

With reference to FIG. 2, a functional block diagram of another example data processing system 100 is depicted that facilitates managing artifact information relating to a physical system 150, for example improving traceability of re-baselined engineering-related information.

As depicted in FIG. 2, a first artifact item 120 may be assigned to a first artifact information baseline 122. The first artifact item 120 may be changed so that an amended first artifact item 120′ may be created that may be assigned to a second artifact information baseline 124. Further, there may be a second artifact item 130 that is linked to the first artifact item 120 assigned to the first artifact information baseline 122 via a connector 134, whereby the second artifact item 130 is further linked to the amended first artifact item 120′ assigned to the second artifact information baseline 124 via an updated connector 136. Since the first artifact item 120 is changed from the first artifact information baseline 122 to the second artifact information baseline 124, a change flag 132 may be assigned to the linked second artifact item 130.

The second artifact item 130 may be displayed to the user in the artifact information management UI 116, whereby the second artifact item 130 may optionally be highlighted in the artifact information management UI 116.

In some examples, with respect to the respective first artifact item 120 that is linked with the respective second artifact item 130 to which the change flag 132 has been assigned, additionally information about the respective first artifact item 120 and/or information about the change(s) made to the respective first artifact item 120 from the first artifact in-formation baseline 122 to the second artifact information baseline 124 may be displayed to the user in the artifact information management UI 116.

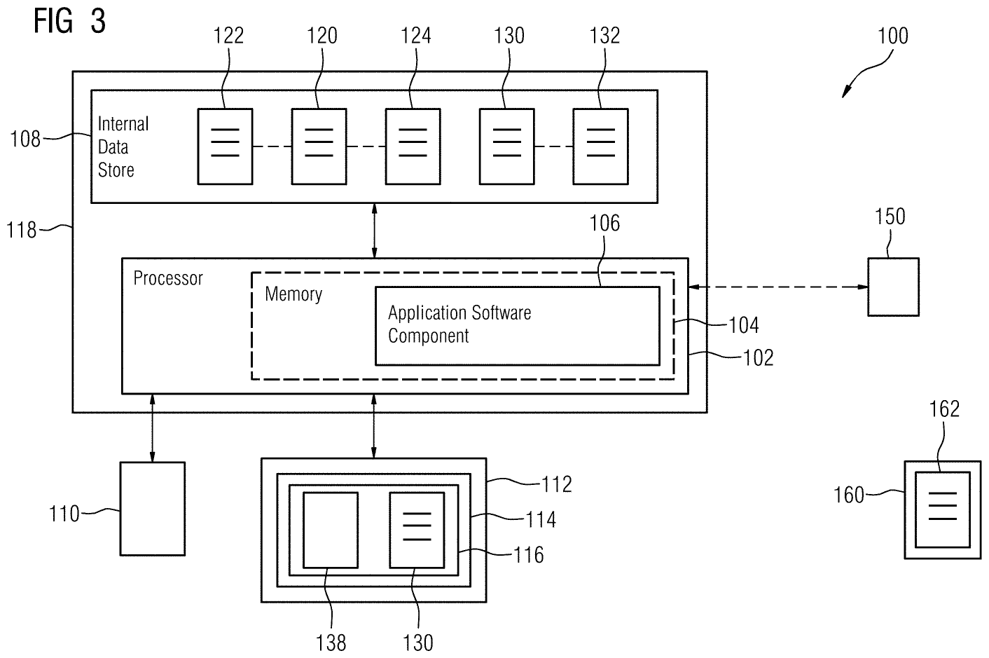

With reference to FIG. 3, a functional block diagram of a further example data processing system 100 is depicted that facilitates managing artifact information relating to a physical system 150, for example improving traceability of re-baselined engineering-related information.

As depicted in FIG. 3, a UI element 138 may be displayed to the user along with the second artifact item 130 to which the change flag 132 is assigned. Hereby, the UI element 138 may indicate the intended removal of the change flag 132 from the second artifact item 130. By way of example, the removal of the change flag 132 may be determined if the change of the first artifact item 120 from the first artifact information baseline 122 to the second artifact information baseline 124 does not affect the linked second artifact item. Further, if the removal of the change flag 132 has been determined, this may be understood as the intended removal of the change flag 132 that may be displayed to the user via the UI element 138. The user may then provide his or her input to confirm or reject the intended removal of the change flag 132, whereby the change flag 132 may be removed from the second artifact item 130 if, or only if the user has confirmed the removal.

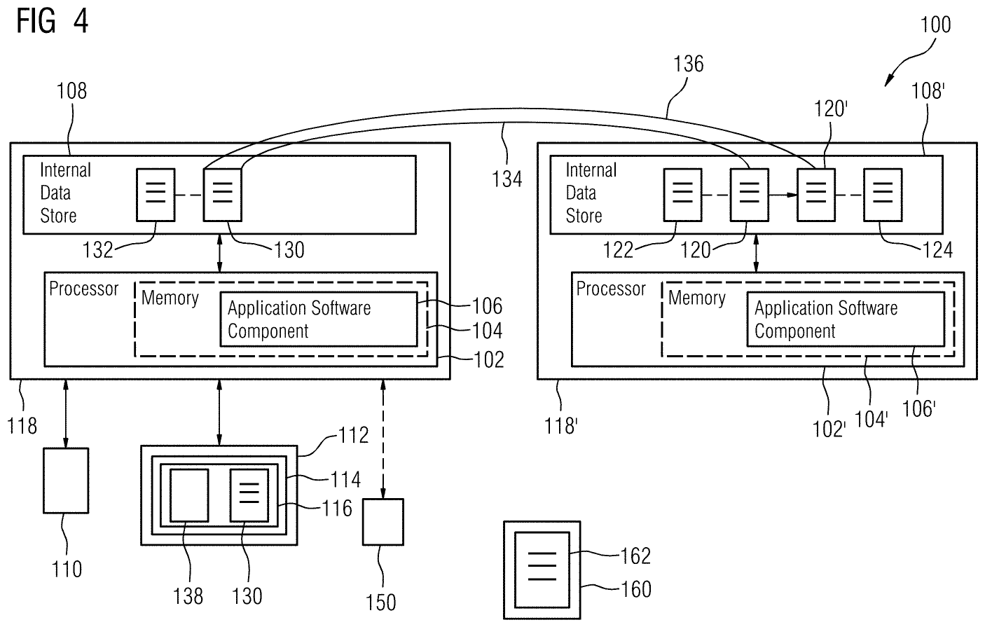

With reference to FIG. 4, a functional block diagram of another example data processing system 100 is depicted that facilitates managing artifact information relating to a physical system 150, for example improving traceability of re-baselined engineering-related information.

As depicted in FIG. 4, the data processing system 100 may include an engineering system 118 and a product lifecycle management system 118′. The engineering system 118 and the product lifecycle management system 118′ may each include at least one processor 102, 102′ that is configured to execute at least one respective application software component 106, 106′ from a respective memory 104, 104′ accessed by the respective processor 102, 102′. The respective application software component 106, 106′ may be configured (i.e., programmed) to cause the respective processor 102, 102′ to carry out various acts and functions described herein. For example, the described application software component 106, 106′ may include and/or correspond to one or more components of an engineering software application or to a PLM or ALM software application that is configured to generate and store product data in a data store 108, 108′ such as a database, respectively.

In the product lifecycle management system 118′, a first artifact item 120 may be assigned to a first artifact information baseline 122. The first artifact item 120 may be changed so that an amended first artifact item 120′ may be created that may be assigned to a second artifact information baseline 124. Herein, the first artifact item 120, the amended first artifact item 120′, the first artifact information baseline 122, and the second artifact information baseline 124 may be stored in the data store 108′ of the product lifecycle management system 118′.

In the engineering system 118, there may be a second artifact item 130 that is linked to the first artifact item 120 assigned to the first artifact information baseline 122 via a connector 134, whereby the second artifact item 130 is further linked to the amended first artifact item 120′ assigned to the second artifact information baseline 124 via updated connector 136. Since the first artifact item 120 is changed from the first artifact information baseline 122 to the second artifact information baseline 124, a change flag 132 may be assigned to the linked second artifact item 130. Herein, the second artifact item 130 and the change flag 132 may be stored in the data store 108 of the engineering system 118.

The second artifact item 130 may be displayed to the user in the artifact information management UI 116, whereby the second artifact item 130 may optionally be highlighted in the artifact information management UI 116. Herein, the artifact information management UI 116 may be generated by the engineering software application that may be provided by the engineering system 118.

Further, information about the respective first artifact item 120, information about the change(s) made to the respective first artifact item 120 and/or a UI element 138 may be displayed to the user along with the second artifact item 130 to which the change flag 132 is assigned as already explained above in the context of FIGS. 2 and 3.

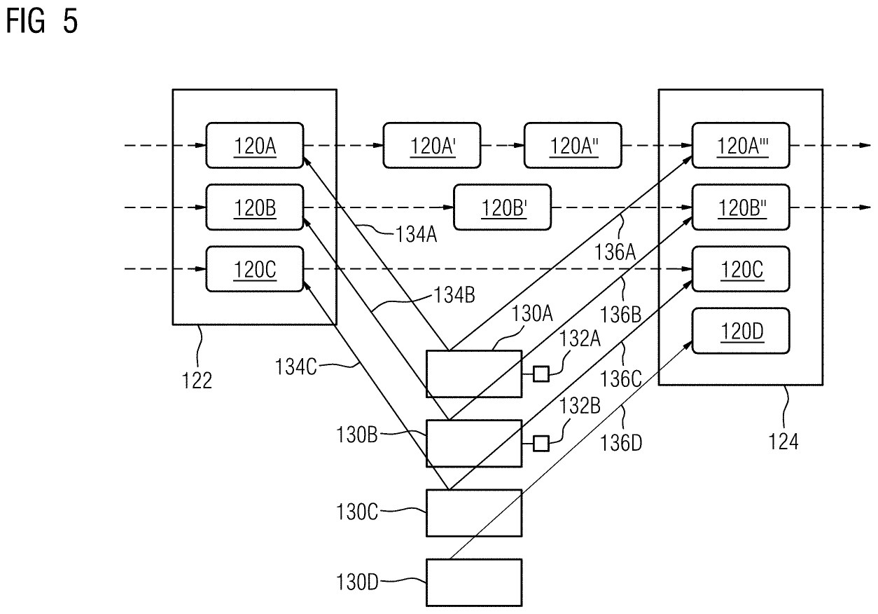

With reference to FIG. 5, an example scenario of artifact information in the context of managing artifact information relating to a physical system 150, for example improving traceability of re-baselined engineering-related information, in a product system, is depicted.

As depicted in FIG. 5, three first artifact items 120A, 120B, 120C may be assigned to a first artifact information baseline 122. From this first artifact information baseline 122 to a later, second artifact information baseline 124, the first artifact item 120A is changed three times, namely in a first step to a first artifact item 120A′, in a second step to a first artifact item 120A″, and in a third step to a first artifact item 120A′″ that is assigned to the second artifact information baseline 124. The first artifact item 120B is changed twice, namely a first step to a first artifact item 120B′, and in a second step to a first artifact item 120B″ that is assigned to the second artifact information baseline 124. The first artifact item 120C remains unchanged so that it is assigned both to the first artifact information baseline 122 and the second artifact information baseline 124. Furthermore, a fourth first artifact item 120D is assigned to the second artifact information baseline 124, but not yet to the first artifact information baseline 122.

Further, four second artifact items 130A, 130B, 130C, 130D may be linked to the above-mentioned four first artifact items 120A, 120B, 120C, 120D. Herein, the second artifact item 130A may be linked to the first artifact item 120A assigned to the first artifact information baseline 122 via a connector 134A. The second artifact item 130A may further be linked to the changed first artifact item 120A′″ assigned to the second artifact information baseline 124 via a connector 136A. The second artifact item 130B may be linked to the first artifact item 120B assigned to the first artifact information baseline 122 via a connector 134B. The second artifact item 130B may further be linked to the changed first artifact item 120B″ assigned to the second artifact information baseline 124 via a connector 136B. The second artifact item 130C may be linked to the first artifact item 120C assigned to the first artifact information baseline 122 via a connector 134C. The second artifact item 130C may further be linked to the first artifact item 120C assigned to the second artifact information baseline 124 via a connector 136C. The second artifact item 130D may be linked to the first artifact item 120D assigned to the second artifact information baseline 124 via a connector 134D.

As explained above, the two second artifact items 130A and 130B are linked with the two first artifact items 120A and 130B that have been changed from the first artifact information baseline 122 to the second artifact information baseline 124, respectively. Accordingly, a respective change flag 132A and 132B may be assigned to the respective second artifact item 130A and 130B.

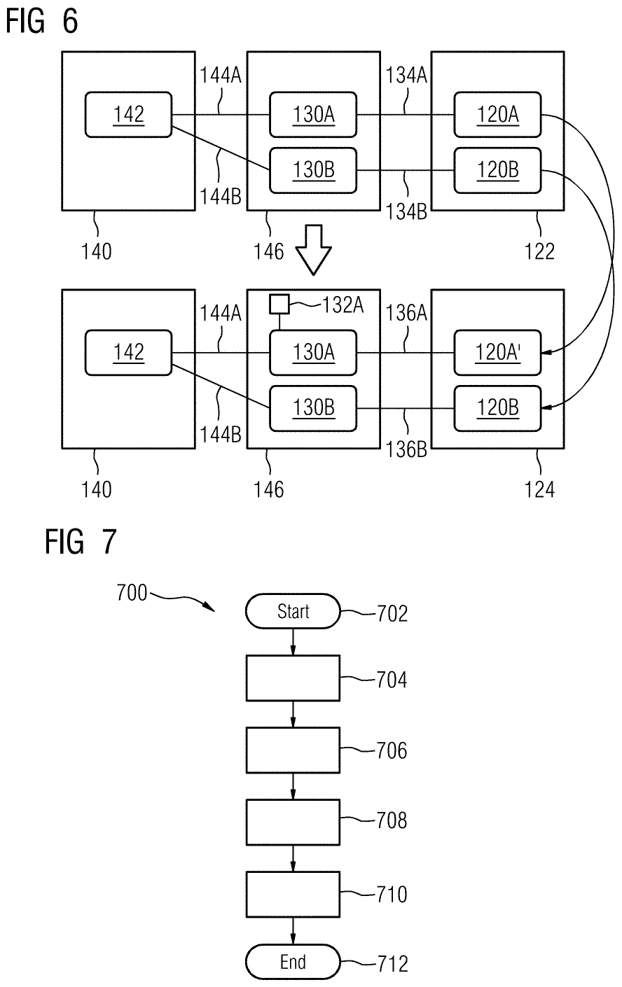

In some examples, an optional change flag 132D or new flag (that is not depicted in FIG. 6) may be assigned to the second artifact item 130D since it is linked to the first artifact item 120D that has newly been introduced at the second artifact information baseline 124, but has no precursor in the previous, first artifact information baseline 122.

With reference to FIG. 6, another example scenario of artifact information in the context of managing artifact information relating to a physical system 150, for example improving traceability of re-baselined engineering-related information, in a product system, is depicted.

As depicted in FIG. 6, two first artifact items 120A, 120B may be assigned to a first artifact information baseline 122. From this first artifact information baseline 122 to a later, second artifact information baseline 124, the first artifact item 120A is changed to a first artifact item 120A′ that is assigned to the second artifact information baseline 124. The first artifact item 120B remains unchanged so that it is assigned both to the first artifact information baseline 122 and the second artifact information baseline 124.

Further, two second artifact items 130A, 130B may be linked to the above-mentioned two first artifact items 120A, 120B. Herein, the second artifact item 130A may be linked to the first artifact item 120A assigned to the first artifact information baseline 122 via a connector 134A. The second artifact item 130A may further be linked to the changed first artifact item 120A′ assigned to the second artifact information baseline 124 via a connector 136A. The second artifact item 130B may be linked to the first artifact item 120B assigned to the first artifact information baseline 122 via a connector 134B. The second artifact item 130B may further be linked to the first artifact item 120B assigned to the second artifact information baseline 124 via a connector 136B.

Since the second artifact item 130A is linked with the first artifact item 120A that has been changed from the first artifact information baseline 122 to the second artifact information baseline 124 a change flag 132A may be assigned to the second artifact item 130A. Hereby, the two second artifact items 130A, 130B, and optionally the change flag 132A, may be included by an engineering model artifact 146 that is linked with an engineering model 140. This link may, e.g., be such that an engineering model item 142 included by the engineering model 140 may be linked to the second artifact item 130A and the second artifact item 130B via an engineering link 144A and an engineering link 144B, respectively. In some examples, the engineering model 140 and the engineering model artifacts 146 may be managed by an engineering software application that is provided to a user via an engineering system, whereby the first artifact items 120A, 120B, the first artifact information baseline 122 and the second artifact information baseline 124 may be managed by a product lifecycle management software application that is provided to the user via a product lifecycle management system.

Referring now to FIG. 7, a flow diagram of an example methodology is depicted that facilitates managing artifact information relating to a physical system, for example improving traceability of re-baselined engineering-related information, in a product system. The methodology M may start at 702 and may include several acts carried out through operation of at least one processor.

The acts may include an act 704 of providing at least one first artifact item, wherein the respective first artifact item is assigned to a first artifact information baseline and to a subsequent second artifact information baseline; an act 706 of providing at least one second artifact item, wherein the respective second artifact item is linked with the respective first artifact item; an act 708 of assigning a change flag to the respective second artifact item if the respective first artifact item to which the respective second artifact item is linked has been changed from the first artifact information baseline to the second artifact information baseline; and an act 710 of displaying the respective second artifact item to which the change flag has been assigned to a user via an artifact information management user interface (UI). At 712 the methodology may end.

It should further be appreciated that the methodology 700 may include other acts and features discussed previously with respect to the computer-implemented method of managing artifact information relating to a physical system, for example improving traceability of re-baselined engineering-related information.

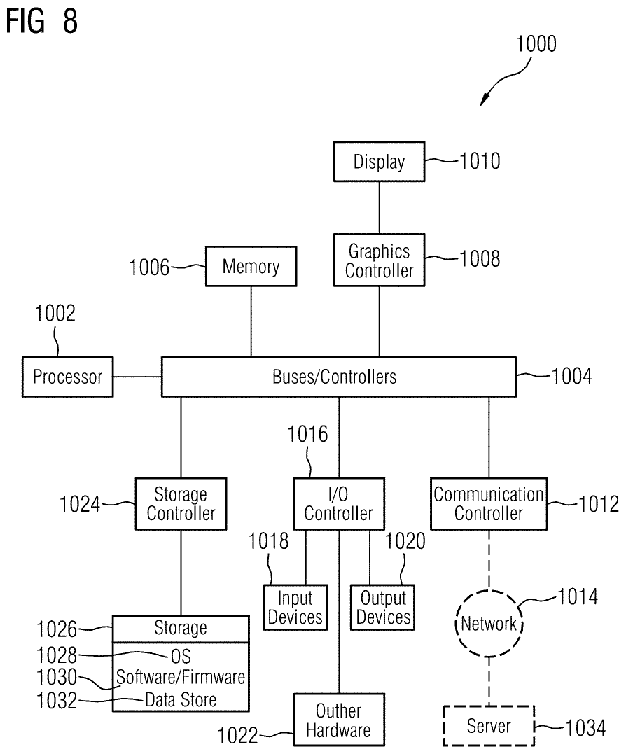

FIG. 8 depicts a block diagram of a data processing system 1000 (also referred to as a computer system) in which an embodiment may be implemented, for example, as a portion of a product system, and/or other system operatively configured by software or otherwise to perform the processes as described herein. The data processing system 1000 may include, for example, the computer or IT system or data processing system 100 mentioned above. The data processing system depicted includes at least one processor 1002 (e.g., a CPU) that may be connected to one or more bridges/controllers/buses 1004 (e.g., a north bridge, a south bridge). One of the buses 1004, for example, may include one or more I/O buses such as a PCI Express bus. Also connected to various buses in the depicted example may include a main memory 1006 (RAM) and a graphics controller 1008. The graphics controller 1008 may be connected to one or more display devices 1010. It should also be noted that in some embodiments one or more controllers (e.g., graphics, south bridge) may be integrated with the CPU (on the same chip or die). Examples of CPU architectures include IA-32, x86-64, and ARM processor architectures.

Other peripherals connected to one or more buses may include communication controllers 1012 (Ethernet controllers, WiFi controllers, cellular controllers) operative to connect to a local area network (LAN), Wide Area Network (WAN), a cellular network, and/or other wired or wireless networks 1014 or communication equipment.

Further components connected to various busses may include one or more I/O controllers 1016 such as USB controllers, Bluetooth controllers, and/or dedicated audio controllers (connected to speakers and/or microphones). It should also be appreciated that various peripherals may be connected to the I/O controller(s) (via various ports and connections) including input devices 1018 (e.g., keyboard, mouse, pointer, touch screen, touch pad, drawing tablet, trackball, buttons, keypad, game controller, gamepad, camera, microphone, scanners, motion sensing devices that capture motion gestures), output devices 1020 (e.g., printers, speakers) or any other type of device that is operative to provide inputs to or receive outputs from the data processing system. Also, it should be appreciated that many devices referred to as input devices or output devices may both provide inputs and receive outputs of communications with the data processing system. For example, the processor 1002 may be integrated into a housing (such as a tablet) that includes a touch screen that serves as both an input and display device. Further, it should be appreciated that some input devices (such as a laptop) may include a plurality of different types of input devices (e.g., touch screen, touch pad, keyboard). Also, it should be appreciated that other peripheral hardware 1022 connected to the I/O controllers 1016 may include any type of device, machine, or component that is configured to communicate with a data processing system.

Additional components connected to various busses may include one or more storage controllers 1024 (e.g., SATA). A storage controller may be connected to a storage device 1026 such as one or more storage drives and/or any associated removable media, that may be any suitable non-transitory machine usable or machine-readable storage medium. Examples include nonvolatile devices, volatile devices, read only devices, writable devices, ROMs, EPROMs, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also, in some examples, a storage device such as an SSD may be connected directly to an I/O bus 1004 such as a PCI Express bus.

A data processing system in accordance with an embodiment of the present disclosure may include an operating system 1028, software/firmware 1030, and data stores 1032 (that may be stored on a storage device 1026 and/or the memory 1006). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may include Microsoft Windows, Linux, UNIX, iOS, and Android operating systems. Also, examples of data stores include data files, data tables, relational database (e.g., Oracle, Microsoft SQL Server), database servers, or any other structure and/or device that is capable of storing data, that is retrievable by a processor.

The communication controllers 1012 may be connected to the network 1014 (not a part of data processing system 1000), that may be any public or private data processing system network or combination of networks, as known to those of skill in the art, including the Internet. Data processing system 1000 may communicate over the network 1014 with one or more other data processing systems such as a server 1034 (also not part of the data processing system 1000). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

Further, the term “controller” means any device, system, or part thereof that controls at least one operation, whether such a device is implemented in hardware, firmware, software, or some combination of at least two of the same. It should be noted that the functionality associated with any particular controller may be centralized or distributed, whether locally or remotely.

In addition, it should be appreciated that data processing systems may be implemented as virtual machines in a virtual machine architecture or cloud environment. For example, the processor 1002 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system may vary for particular implementations. For example, the data processing system 1000 in this example may correspond to a computer, workstation, server, PC, notebook computer, tablet, mobile phone, and/or any other type of apparatus/system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

Also, it should be noted that the processor described herein may be located in a server that is remote from the display and input devices described herein. In such an example, the described display device and input device may be included in a client device that communicates with the server (and/or a virtual machine executing on the server) through a wired or wireless network (that may include the Internet). In some embodiments, such a client device, for example, may execute a remote desktop application or may correspond to a portal device that carries out a remote desktop protocol with the server in order to send inputs from an input device to the server and receive visual information from the server to display through a display device. Examples of such remote desktop protocols include Teradici's PCoIP, Microsoft's RDP, and the RFB protocol. In such examples, the processor described herein may correspond to a virtual processor of a virtual machine executing in a physical processor of the server.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, that may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 1000 may conform to any of the various current implementations and practices known in the art.

Also, it should be understood that the words or phrases used herein should be construed broadly, unless expressly limited in some examples. For example, the terms “include” and “include,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to describe various elements, functions, or acts, the elements, functions, or acts should not be limited by the terms. Rather the numeral adjectives are used to distinguish different elements, functions or acts from each other. For example, a first element, function, or act could be termed a second element, function, or act, and, similarly, a second element, function, or act could be termed a first element, function, or act, without departing from the scope of the present disclosure.

In addition, phrases such as “processor is configured to” carry out one or more functions or processes, may mean the processor is operatively configured to or operably configured to carry out the functions or processes via software, firmware, and/or wired circuits. For example, a processor that is configured to carry out a function/process may correspond to a processor that is executing the software/firmware, that is programmed to cause the processor to carry out the function/process and/or may correspond to a processor that has the software/firmware in a memory or storage device that is available to be executed by the processor to carry out the function/process. It should also be noted that a processor that is “configured to” carry out one or more functions or processes, may also correspond to a processor circuit particularly fabricated or “wired” to carry out the functions or processes (e.g., an ASIC or FPGA design). Further the phrase “at least one” before an element (e.g., a processor) that is configured to carry out more than one function may correspond to one or more elements (e.g., processors) that each carry out the functions and may also correspond to two or more of the elements (e.g., processors) that respectively carry out different ones of the one or more different functions.

In addition, the term “adjacent to” may mean: that an element is relatively near to but not in contact with a further element; or that the element is in contact with the further portion, unless the context clearly indicates otherwise.

It is to be understood that the elements and features recited in the appended claims may be combined in different ways to produce new claims that likewise fall within the scope of the present embodiments. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present embodiments have been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method of managing artifact information, the method comprising:
providing at least one first artifact item, wherein the respective first artifact item is assigned to a first artifact information baseline and to a subsequent second artifact information baseline;
providing at least one second artifact item, wherein the respective second artifact item is linked with the respective first artifact item;
assigning a change flag to the respective second artifact item when the respective first artifact item to which the respective second artifact item is linked has been changed from the first artifact information baseline to the second artifact information baseline; and
displaying the respective second artifact item to which the change flag has been assigned to a user via an artifact information management user interface (UI).

2. The computer-implemented method of claim 1, further comprising, with respect to the respective first artifact item which is linked with the respective second artifact item to which the change flag has been assigned:
displaying information about the respective first artifact item about the change made to the respective first artifact item from the first artifact information baseline to the second artifact information baseline to the user via an artifact information management UI.

3. The computer-implemented method of claim 1, further comprising:
highlighting the displayed respective second artifact item to which the change flag has been assigned.

4. The computer-implemented method of claim 1, wherein the respective second artifact item to which no change flag has been assigned is not displayed, highlighted, or displayed and highlighted to the user via the artifact information management UI.

5. The computer-implemented method of claim 1, further comprising:
determining that the respective change of the respective first artifact item from the first artifact information baseline to the second artifact information baseline does not affect the respective linked second artifact item; and
removing the change flag from the respective second artifact item when the respective second artifact item is not affected by the respective change of the respective first artifact item to which the respective second artifact item is linked.

6. The computer-implemented method of claim 5, wherein the respective second artifact item is not affected by the respective change of the respective first artifact item to which the respective second artifact item is linked when the respective change relates to an attribute or a priority of the respective first artifact item.

7. The computer-implemented method of claim 5, further comprising:
receiving the user's or an administrator's input corresponding to a definition of at least one change of the respective first artifact item to which the respective second artifact item is linked, whereby the respective defined change does not affect the respective second artifact.

8. The computer-implemented method of claim 5, further comprising:
displaying a UI element indicating the intended removal of the change flag from the respective second artifact item to the user via the artifact information management UI;
capturing the user's intent to confirm or reject the intended removal of the change flag from the respective second artifact in response to user interactions with the artifact information management UI; and
removing the change flag from the respective second artifact item when the captured user's intent corresponds to a confirmation the intended removal of the change flag from the respective second artifact item.

9. The computer-implemented method of claim 1, further comprising:
providing a respective connector linking the respective second artifact item with the respective first artifact item assigned to the first artifact information baseline; and
replacing the respective connector with a respective updated connector linking the respective second artifact item with the respective first artifact item assigned to the second artifact information baseline.

10. The computer-implemented method of claim 1, wherein the respective first artifact item, the respective second artifact item, or the respective first artifact item and the respective second artifact item relates to engineering information or lifecycle information of a physical system.

11. The computer-implemented method of claim 10, further comprising:
engineering, modeling, simulating, or analyzing the physical system using the respective first artifact item, the respective second artifact item, or the respective first artifact item and the respective second artifact item.

12. The computer-implemented method of claim 10, further comprising when the respective first artifact item, the respective second artifact item, or the respective first artifact item and the respective second artifact item relates to engineering information:
measuring or determining the respective first artifact item, the respective second artifact item, or the respective first artifact item and the respective second artifact item relating to engineering information of the of the physical system using a sensor, computer-aided design (CAD) data, or communication data relating to the physical system.

13. A non-transitory computer readable storage medium comprising a set of computer-readable instructions stored thereon for managing artifact information, the computer-readable instructions which, when executed by at least one processor cause the at least one processor to:
provide at least one first artifact item, wherein the respective first artifact item is assigned to a first artifact information baseline and to a subsequent second artifact information baseline;
provide at least one second artifact item, wherein the respective second artifact item is linked with the respective first artifact item;
assign a change flag to the respective second artifact item when the respective first artifact item to which the respective second artifact item is linked has been changed from the first artifact information baseline to the second artifact information baseline; and
display the respective second artifact item to which the change flag has been assigned to a user via an artifact information management user interface (UI).

14. The non-transitory computer readable storage medium of claim 13, further comprising, with respect to the respective first artifact item which is linked with the respective second artifact item to which the change flag has been assigned, instructions that when executed by the at least one processor cause the at least one processor to:
display information about the respective first artifact item about the change made to the respective first artifact item from the first artifact information baseline to the second artifact information baseline to the user via an artifact information management UI.

15. The non-transitory computer readable storage medium of claim 13, further comprising instructions that when executed by the at least one processor cause the at least one processor to:
highlight the displayed respective second artifact item to which the change flag has been assigned.

16. The non-transitory computer readable storage medium of claim 13, wherein the respective second artifact item to which no change flag has been assigned is not displayed, highlighted, or displayed and highlighted to the user via the artifact information management UI.

17. The non-transitory computer readable storage medium of claim 13, further comprising instructions that when executed by the at least one processor cause the at least one processor to:
determine that the respective change of the respective first artifact item from the first artifact information baseline to the second artifact information baseline does not affect the respective linked second artifact item; and
remove the change flag from the respective second artifact item when the respective second artifact item is not affected by the respective change of the respective first artifact item to which the respective second artifact item is linked.

18. The non-transitory computer readable storage medium of claim 17, wherein the respective second artifact item is not affected by the respective change of the respective first artifact item to which the respective second artifact item is linked when the respective change relates to an attribute or a priority of the respective first artifact item.

19. The non-transitory computer readable storage medium of claim 17, further comprising instructions that when executed by the at least one processor cause the at least one processor to:
receive the user's or an administrator's input corresponding to a definition of at least one change of the respective first artifact item to which the respective second artifact item is linked, whereby the respective defined change does not affect the respective second artifact.
